(19) United States
(12) Patent Application Publication
(10) Pub. No.: US 2008/0043464 A1
(43) Pub. Date: Feb. 21, 2008

(54) Bi-Chromatic Illumination Apparatus

(76) Inventor: Ian Ashdown, West Vancouver (CA)

Correspondence Address: DOUGLAS T. JOHNSON;MILLER & MARTIN, 1000 VOLUNTEER BUILDING, 832 GEORGIA AVENUE, CHATTANOOGA, TN, 37402-2289, US

(21) Appl. No.: 11/833,358

(22) Filed: Aug. 3, 2007

Related U.S. Application Data
(60) Provisional application No. 60/822,680, filed on Aug. 17, 2006.

(51) Int. Cl. F21V 9/10

(52) U.S. Cl. 362/231

(57) ABSTRACT

The present invention provides an illumination apparatus comprising one or more first light-emitting elements and one or more second light-emitting elements and a control system configured to control the operation of the one or more first and one or more second light-emitting elements. As the illumination apparatus according to the present invention is configured to generate utility illumination using two different and substantially monochromatic light-emitting element light sources, the light pollution resulting from the utility illumination generated by the illumination apparatus is reduced, when compared to a polychromatic light source.

The present application claims priority to the Aug. 17, 2006 filing date of U.S. provisional patent application, Ser. No. 60/822,680.

### FIELD OF THE INVENTION

The present invention relates generally to illumination apparatuses and, more particularly to a bi-chromatic illumination apparatus.

### BACKGROUND

Many types of light sources can typically work efficiently in a narrow range of operating conditions which are governed by the physical and chemical properties of the materials used in the light source. There are only a few types of known artificial light sources such as low pressure sodium (LPS) lamps, for example, which are both highly efficient and can generate large amounts of light. While most of these types of light sources only provide quasi monochromatic light they offer utility for a number of outdoor illumination applications. Monochromatic light from LPS lamps, for example, while not enabling colour rendering, can provide high visual contrast under sufficiently high illumination levels. Unfortunately, such monochromatic light is visually unappealing, with people often preferring white light generated by broadband spectral sources. Broadband spectral illumination, however, can cause undesired light pollution and environmental concerns within regions that are proximate as well as remote from the artificial night lighting.

Outdoor luminaires incorporating light sources including incandescent, fluorescent, high-intensity discharge (HID), or LPS lamps are usually equipped with optical systems comprising reflectors, refractors, and opaque shields that redirect light or suppress unwanted light propagation. Optical systems can enable a luminaire to effectively illuminate target surfaces while reducing undesired illumination of other areas. Many highly efficient light sources such as LPS and HID lamps, however, are bulkily shaped and require large optical systems.

In addition, light pollution can be a significant concern for astronomers and conservationists. The American Astronomical Society has noted that light pollution, and in particular urban sky glow caused by directly emitted and reflected light from roadway, residential and security lighting, for example, severely impacts the ability for terrestrial astronomy. Walker's Law is an empirical equation based on sky glow measurements which were obtained from observations of a number of Californian cities, is defined as follows:

I=0.01*P*d^{-2.5} (1)

where I is the increase in sky glow level in percent above the natural background, P is the population of the city, and d is the distance to the center of the city in kilometres.

For example, Tucson (Ariz.) has a population of 500,000 people and is located approximately 60 km from Kitt Peak National Observatory. Tucson would therefore contribute approximately 18 percent to the total sky glow at this observatory.

It has been shown that light pollution can, moreover, have detrimental environmental effects on plants and animal species, for example nocturnal mammals, migratory birds and sea turtles. For example, roadway and security lighting along the coastline of Florida has been shown to result in sometimes catastrophic reductions in the breeding success of several species of sea turtles. For example, bright lights can inhibit adult female turtles from coming ashore to lay their eggs and also lure newly hatched turtles inland rather than for the open sea.

The American Astronomical Society and the International Astronomical Union recommend several solutions for alleviating light pollution. The recommendations include controlling the emitted light by luminaire design and placement, taking advantage of timers and occupancy sensors, using ultraviolet and infrared filters to remove non-visible radiation, and using monochromatic light sources such as low-pressure sodium lamps for roadway, parking lot, and security lighting.

LPS lighting is particularly useful near astronomical observatories because the emitted light is essentially monochromatic with an emission peak at 589 nm. Narrow band rejection filters can then be used to block this region of the spectrum while allowing astronomical observations at other wavelengths. Unfortunately, LPS lamps have a number of disadvantages when used in outdoor luminaires. First, the LPS lamps and their luminaire housings are typically large. For example, the LuxMaster™ product series from American Electric Lighting measures from 0.75 m to 1.35 m in length for 55 W to 180 W lamps. The large anisotropic dimensions of LPS lamps can make the required luminaire optical system bulky and the device can be cost-ineffective. Furthermore, LPS lamps have poor colour rendering indices (CRI) and are inferior to light sources such as high-pressure sodium (HPS) and metal halide lamps, for example. Moreover, the unnatural illumination effects resulting from LPS lamps, make LPS-based roadway lighting an often undesired solution. Consequently, LPS lamps are often limited to security and parking lot lighting for industrial sites. However, light sources with better colour rendering are favoured whenever colour discrimination is more important than energy efficiency such as for certain safety or monitoring applications, for example.

When improving the quality of polychromatic white light it is usually the goal to choose the wavelengths and full width half maximum (FWHM) spectral power distribution of its light sources to obtain the highest possible CRI. Zukauskas et al. in “Optimization of multichip white solid-state lighting source with four or more LEDs”, Proceedings of SPIE 4425, pp. 148-155 (2001) describe results of a photometric analysis of a polychromatic light source such as a solid-state lamp with two or more different coloured LEDs that can generate white light by additive mixing of the emissions from a series of different primary colour LEDs. The results illustrate how the estimated CRI of solid-state lamps with two, three, four, and five primary colours varies with luminous efficacy.

In addition, in 2004 the International Dark-Sky Association introduced its “Fixture Seal of Approval” program in response for the need to classify outdoor luminaires as “dark-sky friendly.” The acceptance criteria, however, are based on the Upward Light Output Ratio of the luminaire, which is essentially a measure of how much of the light emitted by the luminaire is directed upwards rather than towards the ground, which is a function of the optical design of the luminaire.

As identified above there is a need for a new illumination apparatus that can address issues of light pollution while providing a desired colour rendering index.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a bi-chromatic illumination apparatus. In accordance with an aspect of the present invention, there is provided an illumination apparatus for providing utility illumination to an environment while limiting a level of light pollution generated thereby, the apparatus comprising: one or more first light emitting elements for generating light within a first wavelength range; one or more second light-emitting elements for generating light within a second wavelength range; a control system operatively coupled to the one or more first light-emitting elements and the one or more second light-emitting elements, the control system configured to control activation of the one or more first and one or more second light-emitting elements for generating utility illumination; wherein the first wavelength range is about yellow and the second wavelength range is about blue.

### BRIEF DESCRIPTION OF THE FIGURES

FIG. 1 illustrates the spectral power distribution of light emitted by an illumination apparatus according to one embodiment of the present invention.

FIG. 2 an illumination apparatus according to one embodiment of the present invention.

### DETAILED DESCRIPTION OF THE INVENTION

### Definitions

The term “light-emitting element” (LEE) is used to define a device that emits radiation in a region or combination of regions of the electromagnetic spectrum for example, the visible region, infrared and/or ultraviolet region, when activated by applying a potential difference across it or passing a current through it, for example. Therefore a light-emitting element can have monochromatic, quasi-monochromatic, polychromatic or broadband spectral emission characteristics. Examples of light-emitting elements include semiconductor, organic, or polymer/polymeric light-emitting diodes, optically pumped phosphor coated light-emitting diodes, optically pumped nano-crystal light-emitting diodes or other similar devices as would be readily understood by a worker skilled in the art. Furthermore, the term light-emitting element is used to define the specific device that emits the radiation, for example a LED die, and can equally be used to define a combination of the specific device that emits the radiation together with a housing or package within which the specific device or devices are placed.

As used herein, the term “about” refers to a ±10% variation from the nominal value. It is to be understood that such a variation is always included in any given value provided herein, whether or not it is specifically referred to.

Unless defined otherwise, all technical and scientific terms used herein have the same meaning as commonly understood by one of ordinary skill in the art to which this invention belongs.

The present invention arises from the realization that, dark-sky friendly, monochromatic light sources such as LPS lamps provide aesthetically unappealing illumination with poor CRI and are further typically bulky in nature. The present invention seeks to address these shortcomings by providing a bi-chromatic illumination apparatus that can be physically compact and can provide outdoor illumination with a desired CRI, while enabling relatively easy reduction of the light pollution created thereby.

The illumination apparatus according to the present invention comprises one or more first light-emitting elements and one or more second light-emitting elements and a control system configured to control the operation of the one or more first and one or more second light-emitting elements. The one or more first light-emitting elements are configured to emit light within a first wavelength region, wherein the first wavelength region is about the yellow/amber wavelength region. The one or more second light-emitting elements are configured to emit light within a second wavelength region, wherein the second wavelength region is about the blue wavelength region. The combination of the light emitted by the one or more first and one or more second light emitting elements can be controlled in a manner such that the combined light is perceived as substantially white light.

As the illumination apparatus according to the present invention is configured to generate utility illumination using two different and substantially monochromatic light-emitting element light sources, the light pollution resulting from the utility illumination generated by the illumination apparatus is reduced, when compared to a polychromatic light source. For example, when the illumination apparatus according to the present invention is used to illuminate an exterior area, the utility light is added to the existing light present within the exterior area forming additive light, wherein the utility light can be considered light pollution. As the utility light generated by the illumination apparatus according to the present invention is generated by substantially two monochromatic light sources, the light pollution generated by the illumination apparatus can be substantially removed from the additive light by filtering the additive light using two filters, namely a filter configured to remove the first wavelength range and a filter configured to remove the second wavelength range.

In one embodiment of the present invention, the one or more first and one or more second light-emitting elements are selected such that the first wavelength range and the second wavelength range are substantially narrow wavelength bands, and therefore when these narrow wavelength bands are removed from the additive light by filtering thereof, substantially only a small portion of light is removed from the additive light, while substantially enabling the removal of the light pollution generated by the illumination apparatus.

In one embodiment of the present invention, the illumination apparatus can be configured to meet the requirements of the International Dark-Sky Association Fixture Seal of Approval program while also offering professional and amateur astronomers the ability to remove or filter the narrow wavelength band emissions generated by the illumination apparatus from the sky glow.

### Light-Emitting Elements

The one or more first and one or more second light-emitting elements integrated into an illumination apparatus according to the present invention, are selected in order that substantially white utility light can be generated by the illumination apparatus. In particular, the one or more first light-emitting elements are selected in order that they emit light within about the yellow/amber wavelength region. The one or more second light-emitting elements are selected in order that they emit light within about the blue wavelength region.

In one embodiment of the present invention, the one or more first light-emitting elements are selected to emit light which has wavelengths of about 560 nm to about 600 nm. In another embodiment of the present invention, the one or more first light-emitting elements are selected to emit light which has wavelengths of about 570 nm to about 590 nm. In another embodiment of the present invention, the one or more first light-emitting elements emit light which has a wavelength of about 580 nm.

In one embodiment of the present invention, the one or more second light-emitting elements are selected to emit light which has wavelengths of about 450 nm to about 500 nm. In another embodiment of the present invention, the one or more second light-emitting elements are selected to emit light which has wavelengths of about 460 nm to about 490 nm. In another embodiment of the present invention, the one or more second light-emitting elements emit light which has a wavelength of about 480 nm.

In one embodiment, a bi-chromatic illumination apparatus according to the present invention can emit utility light with a CRI of about 20. This desired utility light can be realized when light of about 480 nm and about 580 nm wavelengths is mixed in adequate proportions. These wavelengths substantially correspond to a blue and a yellow/amber colour, and are reasonably close to the dominant wavelength ranges of high-flux LEDs. For example, commercial products such as Luxeon™ blue LEDs (Lumileds Lighting, San Jose, Calif.) have dominant wavelengths of about 460 nm to 490 nm, while Luxeon™ amber LEDs have dominant wavelengths of about 584.5 nm to 597 nm.

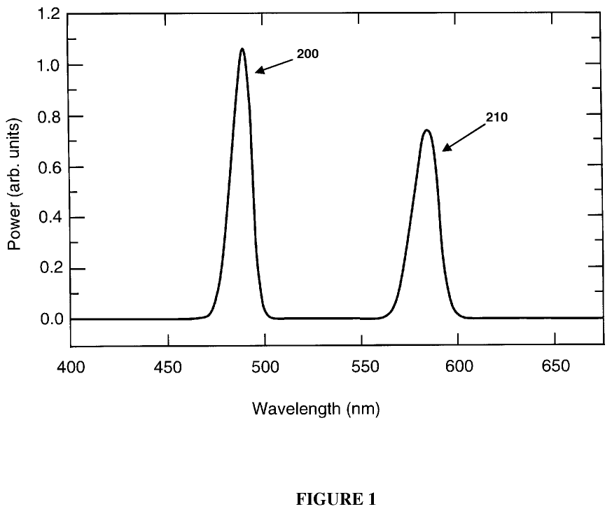

FIG. 1 illustrates a spectral power distribution of an illumination apparatus configured according to one embodiment of the present invention. The spectral power distribution is a result of quasi monochromatic emissions of one or more second light-emitting elements emitting at about 480 nm 200 and one or more first light emitting elements emitting at about 580 nm 210. The appropriate mixing of these two quasi-monochromatic emissions can provide a means for generating substantially white light.

In one embodiment of the present invention, depending on the dominant wavelengths of first and second light-emitting elements used in the illumination apparatus, the light emitted by the one or more about blue light-emitting elements and one or more about yellow/amber light-emitting elements, if adequately mixed, can provide white light with a correlated colour temperature between about 3000K and about 6500K.

In one embodiment of the present invention, colour temperature is a secondary concern for utility light generated for roadway and security lighting applications. Consequently, the dominant wavelengths of the one or more first and one or more second light-emitting elements of the illumination apparatus can be chosen in order to substantially optimize the overall luminous efficacy while also providing a desired CRI.

### Illumination Apparatus

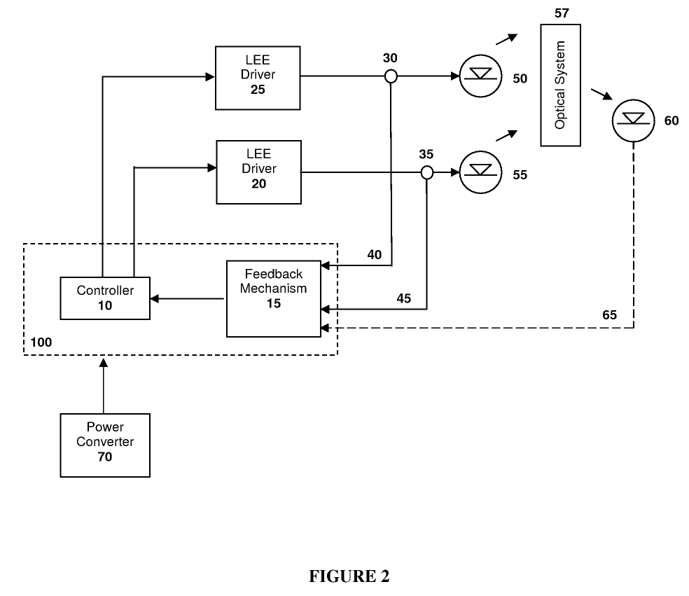

FIG. 2 illustrates an illumination apparatus according to one embodiment of the present invention. The illumination apparatus comprises one or more first light-emitting elements 50 and one or more second light-emitting elements 55. The light emitted by the one or more first and one or more second light-emitting elements is combined into utility illumination. The one or more first light-emitting elements are selected to emit light within substantially the yellow/amber wavelength range and the one or more second light-emitting elements are selected to emit light within substantially the blue wavelength range. Upon the blending of the light emitted by the one or more first and one or more second light-emitting elements, by for example by an optical system 57, the resultant utility light can be substantially white light.

The operation of the one or more first and one or more second light-emitting elements is controlled by a control system 100. In one embodiment of the present invention, the control system 100 comprises a controller 10 and a feedback mechanism 15. Through the use of a feedback mechanism, the luminous flux output of the one or more first and one or more second light emitting elements can be controlled in a manner such that a desired utility light is created, for example substantially white light.

In one embodiment of the present invention, the feedback mechanism can be coupled to a first current sensing mechanism 30 which can provide first information 40 relating to the drive current being supplied to the one or more first light-emitting elements. The feedback mechanism can additionally be coupled to a second current sensing mechanism 35 which can provide second information 45 relating to the drive current being supplied to the one or more second light-emitting elements. Based on the first and second information and the desired utility light, the control system can generate respective control signals for the first LEE driver 25 and second LEE driver 20 in order that the one or more first and one or more second light-emitting elements generate a desired light output, thereby controlling the utility light generated by the illumination apparatus.

In another embodiment of the present invention, the feedback mechanism is coupled to an optical sensor 60, which is configured to provide light information 65 relating to the utility light generated by the illumination apparatus. Based on the light information and the desired utility light, the control system can generate respective control signals for the first LEE driver 25 and second LEE driver 20 in order that the one or more first and one or more second light emitting elements generate a desired light output.

In another embodiment of the present invention, the feedback mechanism is coupled to a current feedback mechanism and an optical sensor, for controlling the utility light generated by the illumination apparatus.

The optical system of the illumination apparatus can be configured in a plurality of ways in order that the first and second wavelengths of light generated by the one or more first and one or more second light-emitting elements are suitably blended in order to produce the desired utility light. The optical system can comprise one or more optical elements which can be configured as one or a combination of reflective elements, refractive elements, diffractive elements, diffusive elements, holographic elements or other optical element formats as would be known to a worker skilled in the art.

The control system can control the activation of the one or more first and one or more second light-emitting elements using one or a combination of control formats. For example the control system can be configured to use pulse width modulation, pulse code modulation, analog modulation or other control format for controlling the one or more first and one or more second light-emitting elements, as would be known to a worker skilled in the art.

In one embodiment of the present invention, since typical light-emitting elements emit a substantial portion of the total radiant flux within the bounds of the FWHM bandwidth, optional filters can be integrated into the illumination apparatus, wherein the filters can be configured to further narrow the spectral emission of the illumination apparatus without detrimentally reducing the luminous flux output of the illumination apparatus.

As is well known in the art, the dominant wavelengths of LEDs varies with LED junction temperature. Typical temperature variations depend on the LED material system and can be about 0.04 nm per degree Celsius for blue LEDs and about 0.09 nm per degree Celsius for amber LEDs. In one embodiment of the present invention, the illumination apparatus further comprises one or more filter compensation mechanisms which are configured to mitigate the dominant wavelength shift of the one or more first and one or more second light-emitting elements due their respective operational junction temperatures.

### Light Pollution Compensation

As the utility light generated by the illumination apparatus according to the present invention, is generated using two substantially monochromatic light sources, the light pollution generated by the illumination apparatus can be substantially removed by an observer using two different filters, namely a first filter selected to substantially remove light generated by the first substantially monochromatic light source and a second filter selected to substantially remove light generated by the second substantially monochromatic light source.

In one embodiment of the present invention, amber and blue light-emitting elements are used as the one or more first and one or more second light-emitting elements, respectively. As is known in the art, LEDs which emit amber or blue light typically have narrow peaks in their emission spectra with relatively small FWHM. For example, typical FWHM values are 20 nm for Luxeon™ blue LEDs and 14 nm for Luxeon™ amber LEDs. Consequently, the light emitted by these LEDs may be considered to be defined for many practical purposes and can be readily filtered by an observer using appropriate narrow band filters, resulting in a limited reduction in the available light within the visible spectrum. For example, the visible spectrum extends from about 380 nm to about 780 nm, and the light removed therefrom by the above identified appropriate narrow band filters represents less than about 10% of available light to an observer.

If used for outdoor illumination applications, an illumination apparatus according to the present invention can be capable of providing relatively high luminous efficacy and CRI. In addition the illumination apparatus according to the present invention can make light pollution more manageable and provide adequate utility light for outdoor illumination purposes. For example, an illumination apparatus according to the present invention, can reduce undesired environmental effects and can increase the total accessible visible spectrum available for terrestrial astronomical observation.

In one embodiment of the present invention, the illumination apparatus can be controlled to substantially continuously vary the chromaticity of the light emitted thereby from about amber through about white to about blue, depending on the relative radiant intensity of the blue and amber light-emitting elements of the illumination apparatus. As such, the illumination apparatus can be operated in order to reduce environmental impact. For example, an illumination apparatus which is used for roadway and security lighting along certain coastal areas can be switched from white to amber during times when sea turtles are known to come ashore or hatchlings are know to return to the open sea.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

I claim:

1. An illumination apparatus for providing utility illumination to an environment while limiting a level of light pollution generated thereby, the apparatus comprising:
a) one or more first light emitting elements for generating light within a first wavelength range;
b) one or more second light-emitting elements for generating light within a second wavelength range;
c) a control system operatively coupled to the one or more first light-emitting elements and the one or more second light-emitting elements, the control system configured to control activation of the one or more first and one or more second light-emitting elements for generating utility illumination;
wherein the first wavelength range is about yellow and the second wavelength range is about blue.

2. The illumination apparatus according to claim 1, wherein the first wavelength range extends from 560 nm to 600 nm.

3. The illumination apparatus according to claim 1, wherein the second wavelength range extends from 450 nm to 500 nm.

4. The illumination apparatus according to claim 1, wherein the control system comprises a feedback mechanism, the feedback mechanism configured to obtain data relating to the operation of the one or more first light-emitting elements and the one or more second light-emitting elements, the control system configured to control activation of the one or more first light-emitting elements and the one or more second light-emitting elements based on the data.

5. The illumination apparatus according to claim 4, wherein the feedback mechanism comprises a first current sensing mechanism configured to generate data indicative of drive current supplied to the one or more first light-emitting elements.

6. The illumination apparatus according to claim 4, wherein the feedback mechanism comprises a second current sensing mechanism configured to generate data indicative of drive current supplied to the one or more second light-emitting elements.

7. The illumination apparatus according to claim 5, wherein the feedback mechanism comprises a second current sensing mechanism configured to generate data indicative of drive current supplied to the one or more second light-emitting elements.

8. The illumination apparatus according to claim 4, wherein the feedback mechanism comprises an optical sensor configured to generate data indicative of utility light characteristics.

9. The illumination apparatus according to claim 1, further comprising an optical system configured to blend the light within the first wavelength range and the light within the second wavelength range.

10. The illumination apparatus according to claim 9, wherein the optical system comprises one or more optical elements selected from the group comprising reflective element, refractive element, diffractive element, diffusive element and holographic element.

11. The illumination apparatus according to claim 1, wherein the control system is configured to control operation of the one or more first light-emitting elements and the one or more second light-emitting elements using pulse width modulation, pulse code modulation, or analog modulation.

12. The illumination apparatus according to claim 2, wherein the first wavelength range extends from 570 nm to 590 nm.

13. The illumination apparatus according to claim 3, wherein the second wavelength range extends from 460 nm to 490 nm.

14. The illumination apparatus according to claim 12, wherein the first wavelength range is about 580 nm.

15. The illumination apparatus according to claim 13, wherein the second wavelength range is about 480 nm.

16. Use of the illumination apparatus according to claim 1 for illuminating areas contributing to light pollution.
